(19) United States
(12) Patent Application Publication
(10) Pub. No.: US 2009/0183891 A1
(43) Pub. Date: Jul. 23, 2009

(54) ADJUSTABLE JUNCTION BOX

(76) Inventor: Wayne A. Kramer, JR., Hanover, PA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/357,848

(22) Filed: Jan. 22, 2009

Related U.S. Application Data
(60) Provisional application No. 61/011,837, filed on Jan. 22, 2008.

(51) Int. Cl. H01R 13/46

(52) U.S. Cl. 174/57; 174/53

(57) ABSTRACT

An adjustable electrical junction box with an adjustable sleeve that can be slidably mounted onto the junction box. The sleeve is attached to the junction box by four screws that connect to tapped openings on the junction box to allow the screws to rotate freely. The screws are also connected to the sleeve through threaded tabs that allow the sleeve to slide along the screws as the screws are adjusted.

### CROSS-REFERENCE TO RELATED APPLICATIONS

This application claims the benefit under 35 U.S.C. §119(e) of U.S. Provisional Application No. 61/011,837 entitled “ADJUSTABLE JUNCTION BOX” filed on Jan. 22, 2008, which is incorporated herein by reference, in its entirety.

### BACKGROUND OF THE INVENTION

1. Field of the Invention

This invention generally relates to the field of electrical junction boxes. Particularly to a junction box that can be adjusted as desired to fit flush against a wall.

2. Background

Electrical junction boxes are mounted onto the frames of the walls of a building, typically during initial construction. Access to the junction boxes is provided through openings in the walls. These junction boxes are closed on all sides except where joined to the building's wiring and except for the fronts of the boxes that face the openings in the walls.

It is desirable that the open front of the junction box be positioned adjacent to the surface of the wall so that when an electric switch or outlet is mounted in the junction box, the front of the switch or outlet will be substantially flush with the surface of the wall. However, because of the wide variety of types of walls in which the electrical junction boxes are installed, and because the junction boxes are typically installed before the wall surfaces are applied to studs or the like, it is difficult to estimate the exact location of the junction box to ensure that the front of the switch or outlet will be flush with the wall surface in the finished product. Furthermore, sometimes the stud to which the junction box is to be attached may be twisted resulting in the junction box being skewed in relation to the planar surface of the wall. If the junction box protrudes out from the wall surface, then the switch or outlet will appear unsightly, whereas if the junction box is recessed too far from the wall surface, then the switch or outlet to be mounted therein may not be held tight in the junction box and may not be adequately protected from spark or other electrical hazards reaching surrounding combustible materials. In addition, if the junction box is too far recessed from the wall surface, it may not even be possible to mount the switch or outlet therein. Furthermore, if the junction box is twisted, the resultant switch or outlet mounting may be unsightly or unsafe.

A number of adjustable electrical outlet boxes have been proposed to allow mounting a switch or outlet so that it is substantially flush with a wall surface. Among these are those disclosed in U.S. Pat. Nos. 1,875,101; 2,048,611; 3,433,886; and 4,634,015. These arrangements all show a combination specialized junction box and slidable element for holding a switch or outlet and, as such, require installation of the specialized junction box everywhere the device is to be used. These devices, however, typically only allow the junction box to be adjusted in or out with respect to the wall surface, and do not enable correction of angular displacement. As a result, sometimes even when using these devices, the junction box protrudes from the walls unevenly.

### SUMMARY OF THE INVENTION

The present invention enables a junction box to be adjusted in multiple directions in order to provide flush outlets and switches. Other and additional objects of this invention will become apparent from a consideration of this entire specification.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a perspective view of an adjustable junction box in accordance with the present invention.

FIG. 2 is an anterior view of the adjustable junction box of the present invention.

FIG. 3 is a side view of the adjustable junction box of the present invention.

FIG. 4 is a perspective view of the adjustable junction box of the present invention.

### DETAILED DESCRIPTION

The invention summarized above and defined by the enumerated claims may be better understood by referring to the following description, which should be read in conjunction with the accompanying claims and drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

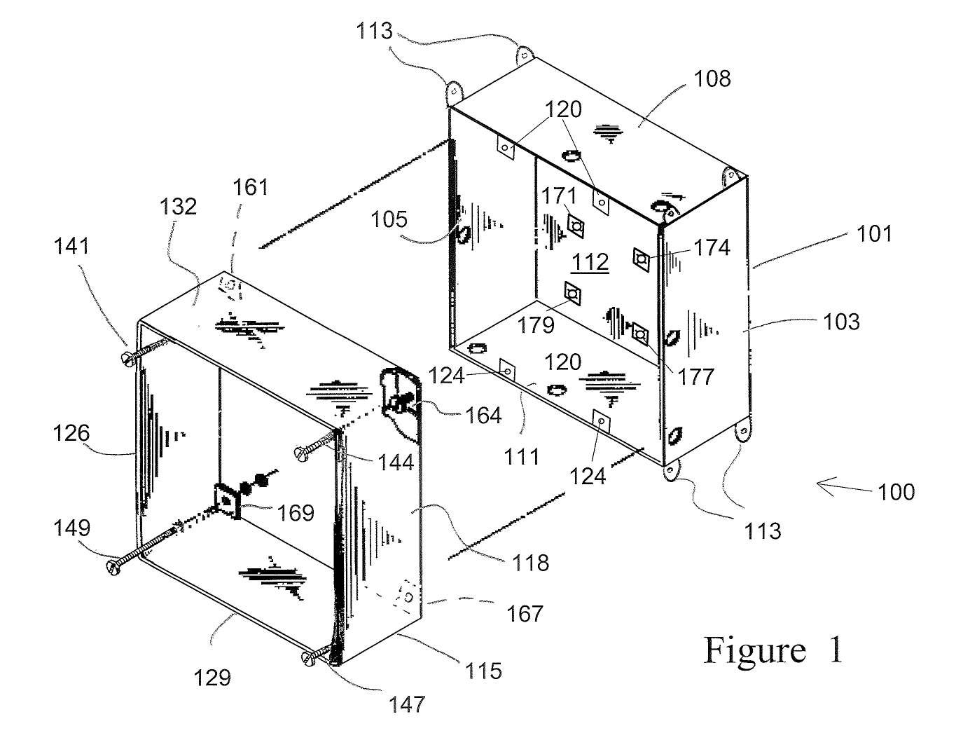

Shown in FIG. 1 is one embodiment of an adjustable electrical outlet box assembly, indicated generally as 100, according to an embodiment of the present invention. The assembly 100 consists of a junction box 101 with two vertical sides 103 and 105, a horizontal top 108 and bottom 111, and a back side 112. The junction box 101 may be attached to a wall-frame stud through any of the sides 103 and 105, top 108, bottom 111, and/or back side 112. The junction box 101 can be nailed, screwed, or fastened to wall-studs, as contemplated by a person of ordinary skill in the art. It is further contemplated that the junction box 101 may have other fastening means such as extensions 113 protruding from the sides 103 and/or 105, at right angles from the top 108 and/or bottom 111. Alternatively, such extensions may protrude from the top 108 and/or bottom 111, at right angles from the sides 103 and/or 105. It is contemplated that the junction box 101 may have different shapes; in such cases, the sleeve or tube described below may have sides that are symmetrically similar to those of the junction box.

Slidably mounted within the junction box 101 is a rectangular sleeve/tube 115 having sidewalls 118 and 126, a bottom side 129, and a top side 132; all the sides of which are generally parallel with the walls 103, 105, 108, and 111 of the junction box 101, respectively. When the junction box is not rectangular, the sleeve may have sides that are symmetrically similar to those of the junction box. The sleeve 115 has no front or back wall and is dimensioned to allow the mounting therein of conventional electrical switches, electrical wall outlets, and the like. A pair of tabs 120 extend inwardly from opposite front edges of the junction box 101 and each tab 120 includes a threaded opening 124 arranged to allow the mounting thereon of electrical switches or outlets. It is contemplated that in some embodiments of the invention there may be more than one pair of tabs 120, such as shown in FIG. 1, so as to allow the addition of multiple outlets and switches or combinations thereof. The sleeve/tube 115 is also dimensioned to fit within the junction box 101 so that the sleeve/tube 115 can be adjusted in any direction and not interfere with access to tabs 120.

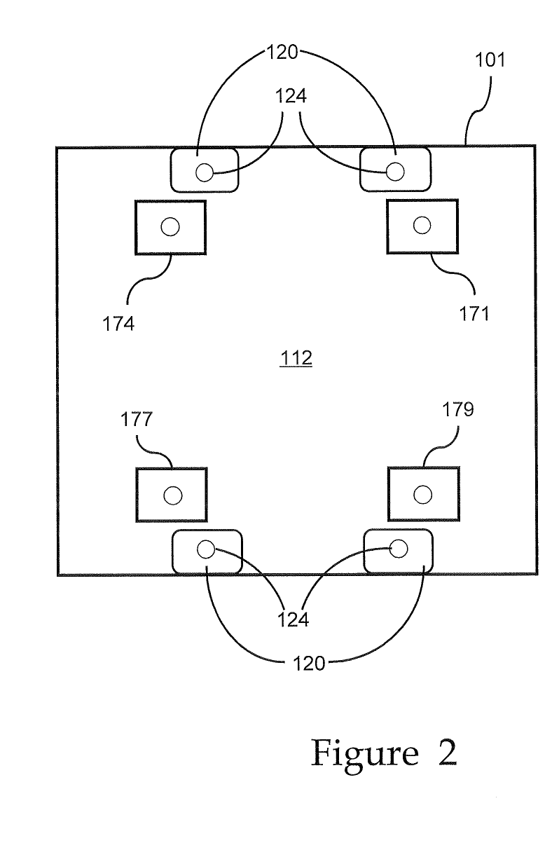

The sleeve/tube 115 is movable forwardly and rearwardly of the junction box 101 by appropriate adjustment of any of four threaded fasteners 141, 144, 147, and 149, which are positioned at each corner of the sleeve/tube 115. The threaded fasteners 141, 144, 147, 149 may be bolts or any other structure understood by a person of ordinary skill in the art to allow the sleeve/tube 115 to slide along an axis of threaded fastener. It is contemplated that the threaded fasteners 141, 144, 147, 149 may be placed in any such configuration as to allow the sleeve/tube 115 to be angularly adjusted in reference to a plane formed by the front edges of the junction box 101. The threaded fasteners 141, 144, 147, 149 may be inserted into threaded openings in tabs 161, 164, 167, and 169, respectively, located on each corner of the sleeve/tube 115 and project inwardly from the interior wall of the sleeve/tube 115. The threaded fasteners 141, 144, 147, 149 may be placed in any such configuration that allows angular adjustment of the sleeve/tube 115. The ends of threaded fasteners 141, 144, 147, 149 are rotatably fixed in tapped tabs 171, 174, 177, and 179, which are position on the back side 112 of the junction box 101, as shown in FIG. 2. With this arrangement, when any of the threaded fasteners 141, 144, 147, 149 are rotated, the ends thereof remain in place in the tapped tabs 171, 174, 177, 179, while the tabs 161, 164, 167, 169, and thus the sleeve/tube 115, is caused to move longitudinally along the length of the threaded fasteners in a direction determined by the direction in which the threaded fasteners are rotated. Rotation of the threaded fasteners in one direction causes the sleeve/tube 115 to move toward the back side 112 of the junction box 101, whereas rotation of the threaded fasteners in the opposite direction causes the sleeve/tube 115 to move away from the junction box 101 toward an extended position. In this manner, the position of the sleeve/tube 115 can be varied by simple adjustment of the threaded fasteners 141, 144, 147, 149. Each threaded fastener 141, 144, 147, 149 can be adjusted separately, allowing the sleeve/tube 115 to be positioned in any desired configuration such as allowing one corner or one side to protrude further than another side or corner in order to compensate for variations in the studs onto which the outlet box assembly 100 is placed. Such adjustment allows the sleeve/tube 115 to be angularly adjusted with respect to a plane formed by the front edges of the junction box 101. Thus allowing the outlets or switches installed in the junction box 101 to be flush with the wall to which they are attached.

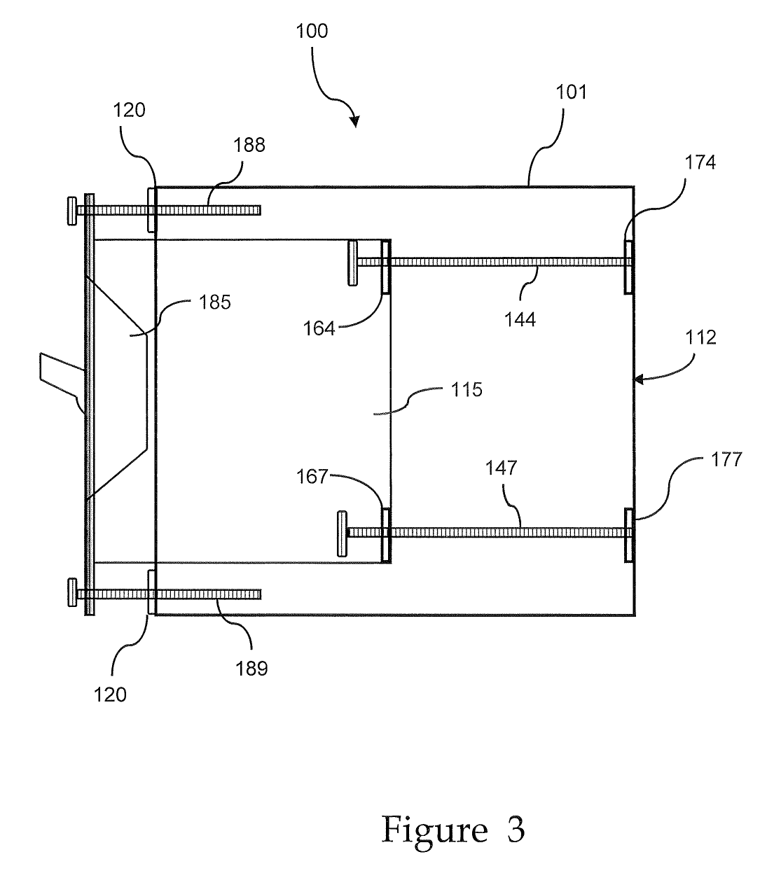

Referring to FIG. 3, a switch 185 is shown mounted in the outlet box assembly 100. The sleeve/tube 115 has been adjusted with respect to the junction box 101 in order to enable the open edge of the sleeve/tube 115 to be flush with the wall in which the outlet box assembly 100 is installed. Screws 188, 189, which are typically provided with the switch 185, are attached to tabs 120 and hold the switch 185 against the sleeve/tube 115. In this manner, the sleeve/tube 115 acts as a stop against which the switch 185 is held in place.

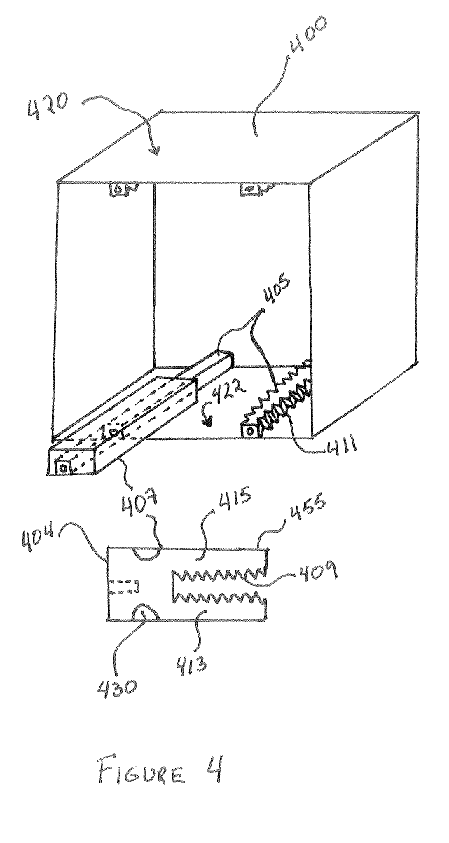

A further embodiment of the present invention, shown in FIG. 4, consists of a junction box 400 with removable receptacles 407 for outlet screws. The removable receptacles 407 are designed to fasten to couplings 405 in the junction box 400. It is contemplated that the removable receptacle 407 and the coupling 405 may be constructed in such a way as to allow the removable receptacle 407 to releasably attach to the coupling 405. Once connected, the removable receptacle 407 and coupling 405 remain connected unless a specific action to displace the removable receptacle 407 is taken.

In one example, the removable receptacle 407 may consist of a first section 404 and a second section 455. The first section 404 may contain a threaded portion to receive a fastener, such as 188, 189 above, that allows an electrical outlet or switch to be secured to the junction box 400. The second section 455 may contain receptacle teeth 409 that engage coupling teeth 411. In order to engage the receptacle teeth 409 and the coupling teeth 411, pressure may be applied to the removable receptacle 407 causing a first receptacle leg 413 to move away from a second receptacle leg 415 and engage the coupling 405. This pressure may be applied at a pressure point 430 that allows the first receptacle leg 413 and the second receptacle leg 415 to move away from one another.

It is to be understood that the removable receptacle 407 may be fastened to the coupling 405 in any other ways contemplated by a person of ordinary skill in the art. For example, the removable receptacle 407 and coupling 405 may have holes capable of being aligned and through which a small bar can be inserted to secure the removable receptacle 407 in place. In some embodiments of the present invention, the coupling may extend along the top 420 and bottom 422 of the junction box 400. In other embodiments, the coupling may be a single opening on the side of a traditional tab for outlet screws with a fastener similar to a zip-tie fastener that allows a first receptacle leg 413 or a second receptacle leg 415 to be inserted and locked in place.

The embodiment described above and shown in FIG. 4, allows a person installing a junction box, outlet, and cover to adjust each removable receptacle 407 independently. Thus, one removable receptacle 407 may extend further away from the junction box than another removable receptacle 407. If the junction box is not squared with the drywall where the outlet or switch is to be placed, either because the junction box was improperly mounted or due to a stud that is twisted, the removable receptacles 407 allow the outlet or switch to be attached to the junction cover flush with the wall providing a more aesthetically pleasing look to the finished wall.

The invention has been described with references to a preferred embodiment. While specific values, relationships, materials, and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments shown and described will obviously occur to those skilled in the art upon becoming familiar with said underlying concept. It is intended to include all such modifications, alternatives and other embodiments in this invention. It should be understood, therefore, that the invention may be practiced otherwise than as specifically set forth herein. Consequently, the present embodiments are to be considered in all respects as illustrative and not restrictive.

What is claimed is:

1. An apparatus for mounting electrical switches and outlets, comprising:
a junction box having a plane formed by one or more edges of said junction box; and
an angularly adjustable sleeve that is capable of being adjusted at different angles in relation to said plane.

2. The apparatus of claim 1, wherein one or more sides of said angularly adjustable sleeve are symmetrically similar to one or more sides of said junction box.

3. The apparatus of claim 1, wherein said junction box further comprises one or more threaded fasteners that allow for the adjustment of the angularly adjustable sleeve.

4. A sleeve for an electrical junction box, comprising:
a tube that is sized and configured to fit in an electrical junction box, said tube being adapted to be angularly adjusted in relation to a plane of said junction box, said plane formed by one or more sides of said junction box.

5. An adjustable junction box, comprising:
a coupling, and
a removable receptacle that is releasably connected to the coupling.

6. The adjustable junction box of claim 5, wherein said removable receptacle is adjustable with respect to a front edge of said junction box to extend beyond the edge of said junction box.

7. The adjustable junction box of claim 5, wherein an electrical outlet can be attached to said removable receptacle.

8. The adjustable junction box of claim 5, wherein said removable receptacle comprises:
a first section having a receptacle for a fastener, and
a second section adapted to be releasably connected to said coupling.

9. The adjustable junction box of claim 5, wherein:
said removable receptacle comprises a first leg and a second leg, wherein each of said first leg and second leg comprise leg teeth; and
said coupling comprises coupling teeth that prevent the removable receptacle from moving relative to said coupling after said removable receptacle is installed on the coupling.

10. A removable receptacle for an electrical junction box, comprising:
a first section having a receptacle for a fastener, and
a second section adapted to connect to a junction box.

11. The removable receptacle of claim 9, wherein said second section comprises
a first leg, and
a second leg, wherein said first leg and second leg are adapted to be releasably attached to a junction box.
